(19) United States
(12) Patent Application Publication
(10) Pub. No.: US 2021/0323099 A1
(43) Pub. Date: Oct. 21, 2021

(54) METHOD FOR THERMALLY CONNECTING TWO WORKPIECE SECTIONS

(71) Applicants: ThyssenKrupp Steel Europe AG, Duisburg (DE); thyssenkrupp AG, Essen (DE)

(72) Inventor: Michael BRÜGGENBROCK, Rosendahl (DE)

(73) Assignees: ThyssenKrupp Steel Europe AG, Duisburg (DE); thyssenkrupp AG, Essen (DE)

(21) Appl. No.: 17/259,541

(22) PCT Filed: Jul. 11, 2019
(86) PCT No.: PCT/EP2019/068660

§ 371 Date: Jan. 11, 2021

(30) Foreign Application Priority Data
Jul. 12, 2018 (DE) 10 2018 211 574.5

(51) Int. Cl. B23K 33/00; B23K 37/06

(52) U.S. Cl. CPC B23K 33/00; B23K 2103/04; B23K 37/06

(57) ABSTRACT

The invention relates to a method for thermally connecting at least two workpiece sections, wherein at least a first and second workpiece section are provided, wherein at least the first workpiece section comprises an edge (1.1, 1.1′, 1.1″, 1.1′″) and the edge (1.1, 1.1′, 1.1″, 1.1′″) defines a termination of an edge section (1.2, 1.2′, 1.2″, 1.2′″), the first and second workpiece sections are positioned relative to one another in such a way that they are connected to one another at least in certain sections in their longitudinal extent, wherein the edge section (1.2, 1.2′, 1.2″, 1.2′″) has a defined geometry. According to the invention, the defined geometry of the edge section (1.2, 1.2′, 1.2″, 1.2′″) is dimensioned in such a way that a local region in the cross section of the edge section (1.2′) is provided with a maximum thickness (t_{max1′}) at a distance (1.3′) from the edge (1.1′).

### TECHNICAL FIELD

The invention relates to a method for thermally connecting at least two workpiece sections, wherein at least a first and a second workpiece section are provided, wherein at least the first workpiece section comprises an edge and the edge defines a termination of an edge section, the first and second workpiece sections are positioned relative to one another in such a way that they are connected to one another at least in certain sections in their longitudinal extent, wherein the edge section has a defined geometry. The invention also relates to a workpiece group.

### TECHNICAL BACKGROUND (BACKGROUND ART)

Vehicle bodies are assembled from numerous components, in particular the components are joined to one another in accordance with standard practice, in particular thermally joined to one another, preferably welded to one another. The joints or welds on or between, respectively, components in a vehicle body usually define weak points in the structure of the vehicle body. It is not the weld seam resulting from a thermal welding process between at least two components that is responsible as failure location in the event of stress (of undefined magnitude), for example in the form of an accident, but rather the transition region from the base material of the component(s) to the weld seam, said region being defined as heat-affected zone (HAZ) in the case of thermal welding. The material properties are changed in the HAZ as a result of the melting of the base material and the subsequent solidification.

The production of multi-phase, ultra-high-strength quality steels, which are used in modern vehicle bodies, is characterized by their special chemical compositions, and also by thermomechanical rolling processes with small process windows. As a result of the thermal joining of these steels, the elaborately set microstructure of such steels made of ferrite, bainite and/or martensite is melted in the center of the joint and cooled in an undefined manner. In the region of the HAZ, the microstructure undergoes an undefined heat treatment owing to the heat conduction from the melting region. The change in the material properties in the region of the joint (connection/weld seam and HAZ) is referred to as a metallurgical notch.

A further failure location or crack start location in the region of the joint is referred to as a geometric notch. Here, the notch effect is caused by the geometric inhomogeneity of the weld seam. In particular, at the transition from the base material to the weld metal there is an abrupt, sharp edge which is at least directly in the force flow of the joint and can be the starting point for cracks and can thus lead to failure of the joint. For component walls above 2 . . . 4 mm (depending on the weld seam shape), DIN EN ISO 9692-1:2013 shows weld seam preparation, which makes a single-layer or multi-layer weld seam over the entire material cross section of the base material with root and top layer possible. Weld seam preparation corresponds to the removal of material by grinding, milling, sawing or cutting in order for the welding source to reach deeper into the material cross section of the base material.

“Thinner” component walls (0.5 . . . 3 mm) generally do not undergo weld seam preparation, welding preferably being performed with filler material (wire), since the lack of material (as seen in cross section) here means that there is a very high risk of holes developing, for example. In particular in the case of gas metal arc welding (MSG), the filler material is usually unfavorably applied above the joint. Joining without filler material, in particular in the case of laser beam welding, results in a seam cross section which is smaller in contrast to the base material (depending on the joining technique and design) and in which the acting forces then also cause higher stresses. Further imperfections in the joint, which are regulated and limited in DIN EN ISO 5817, further increase the locally occurring stresses, in particular as a result of a reduction in the seam cross section able to bear loads, and thus the probability of failure, for example inaccuracies such as edge height offset and different gap widths for example in butt welding.

In particular, the combination or superimposition of these causes of failure makes it necessary to dimension the component thicknesses according to the joints. As a result, all of the components are overdimensioned in terms of their wall thickness, although a greater component thickness would only be necessary at the joints. The high component thicknesses stand in the way of general lightweight construction efforts and resource efficiency. Ultra-high-strength steels, in particular, are thereby restricted in their application because, in the case of said steels, the metallurgical notch is particularly pronounced and the geometric notch sensitivity is very high.

To reduce metallurgical notch peaks or to reduce the stress peaks introduced by means of joining, the joined components can undergo a heat treatment (annealing) for homogenization. However, this heat treatment requires at least one further process step and, owing to the heat input, can have a disadvantageous effect on the particularly pronounced and deliberately set properties (microstructure, possibly coating) of the components.

To reduce the geometric notch sensitivity, joint seams can be machined mechanically, in particular by cutting, in order to reduce the potential for cracks especially in the case of joint seam superelevations. This measure also requires at least one further process step along with additional expenditure on equipment.

U.S. Pat. No. 1,161,419 describes a method for thermally connecting two pieces of sheet metal which are butt-jointed to one another. The edges to be connected in the butt joint are increased in terms of their thickness by material displacement to increase the seam cross section. The enlargement of the weld seam as a geometric size makes it possible for the static load-bearing capacity of the connection between the sheet metal pieces to be increased in the middle of the connection zone.

With regard to the prior art and in particular with a view to the harmonization of the strength profile (metallurgical notch) and the geometry (geometric notch) in the connection/weld seam, there is, however, further need for optimization, in particular with regard to the processing of new, thin-walled, ultra-high-strength steel materials, in particular substantially dependent on the joining technology, the type of joint, the wall thickness and the material used.

### SUMMARY OF THE INVENTION

The invention is based on the object of providing a method for thermally connecting two workpiece sections, with which method a harmonious transition between the base material(s) and the connection seam can be made possible between the connected workpiece sections substantially without additional process steps.

This object is achieved by a method for thermally connecting at least two workpiece sections having the features of patent claim 1. Further advantageous embodiments of the invention are listed in the subordinate claims.

According to the invention, a method for thermally connecting at least two workpiece sections is proposed, wherein at least a first and a second workpiece section are provided, wherein at least the first workpiece section comprises an edge and the edge defines a termination of an edge section, the first and second workpiece sections are positioned relative to one another in such a way that they are connected to one another at least in certain sections in their longitudinal extent, wherein the edge section has a defined geometry.

According to the invention, the first workpiece section is to be understood as an edge of a first workpiece with an associated edge section. According to the invention, the second workpiece section is to be understood as either an edge of a second workpiece with an associated edge section or only the edge section of the second workpiece or only a section of the second workpiece as a connecting section.

If the second workpiece section relates to an edge of a second workpiece with an associated edge section, then the first workpiece section comprises an edge and the edge defines a termination of an edge section of the second workpiece, wherein the edge section has a defined geometry. The two edge sections of the two workpiece sections particularly preferably have the same geometry.

The defined geometry of the edge section is dimensioned in such a way that a local region in the cross section of the edge section is provided with a maximum thickness tₘₐₓ at a distance from the edge or at least one section in the transverse extent of the edge section is provided with a maximum thickness tₘₐₓ, in particular with a substantially constant maximum thickness tₘₐₓ, proceeding from the edge.

The inventor has found that, as a result of designing a defined geometry of the edge section and corresponding dimensioning, a positive influence can be exerted on the generation of a harmonious transition, running between the connected workpiece sections, between the base material(s) and the connection seam, without substantially additional process steps needing to be taken into account in the manufacturing process in order to reduce the notch sensitivity. The defined or targeted manner of designing the geometry of the edge section alleviates the geometric notch and ensures a homogeneous flow of force without stress peaks in the notch base. By way of example, the geometry of the edge section is dimensioned in such a way that when loading occurs or in the case of operating stresses resulting from the quotient of operating force to stressed cross section, the connection seam substantially withstands this and, in the event of failure, the failure location is located outside of the connection seam or the HAZ. The configuration according to the invention makes it possible to improve the static strength and/or dynamic operational strength for the connection point.

On the one hand, the defined geometry of the edge section is dimensioned in such a way that a local region in the cross section of the edge section is provided with a maximum thickness tₘₐₓ at a distance from the edge. Alternatively or on the other hand, at least one section in the transverse extent of the edge section is provided with a maximum thickness tₘₐₓ proceeding from the edge, wherein, in other words, a section of the edge section in the transverse extent, proceeding from the edge, is formed with a substantially constant thickness corresponding to the maximum thickness tₘₐₓ, the section or the width thereof being defined and determined, inter alia, in dependence on the joining technology, the type of joint, the wall thickness and the material used. On the one hand, the maximum thickness tₘₐₓ has the task of compensating for the lower strength of the material within the connection seam (compensation for metallurgical notches), and the position of said thickness, whether viewed locally or over a predefined section, is responsible for homogenization and a direct, non-deflected flow of force between the two connected workpiece sections. Furthermore, for example undercuts, which are generally found at the edge of the connection seam, are filled by an accumulation of material, such that this geometric notch is homogenized and there is more material present in this cross section compared with the initial wall thickness (compensation of the geometric notch).

The maximum thickness tₘₐₓ can be determined in particular when a standard connection arrangement with at least two workpiece sections or at least two workpieces has been examined and parameters such as the hardness profile in the cross section of the region of the connection point (base material of first workpiece HAZ of first workpiece connection seam between the first and second workpiece HAZs of second workpiece base material of second workpiece) have been ascertained. In the HAZ, a decline in the hardness profile is often identifiable. In order to enable in particular a reinforcement with regard to the drop in hardness or a harmonious transition between in particular two workpieces, the thickness of the edge or of the edge section of the at least first workpiece is preferably set specifically to compensate for the drop in hardness. The relative drop in hardness is calculated from the quotient of the hardness of the workpiece and the minimum hardness in the HAZ. This quotient is multiplied by the initial thickness or the thickness t of the workpiece to be used and results in the required maximum thickness tₘₐₓ in order to be able to compensate in particular for the metallurgical notch. By way of example, the following equation can be used as equation for designing the maximum thickness tₘₐₓ:

tₘₐₓ=t_{workpiece}*(hardness_{workpiece}/hardness_{min HAZ workpiece}),

with tₘₐₓ and t_{workpiece} in mm, where the quotient of the two hardness values has no units and the hardness values can be determined by means of all common hardness test methods (Vickers, Rockwell, Brinell, etc.). The use of hardness as a parameter is based substantially on the simple ascertainment and the analogy to strength in steel materials.

Flat products with a substantially constant thickness t are preferably used as workpieces. Prior to the thermal connection, the at least first workpiece section with its edge and the edge section adjoining it are subjected to conventional shaping, in particular solid shaping, which leads to the defined geometry of the edge section.

In the connected, welded state, there is thus a homogeneous local load with an adapted cross-sectional stress profile in relation to the local strength of the material after the thermal connection (welding) of the workpieces, with discontinuities in the cross-sectional profile of the thermal connection (homogeneous, closed connection region) being able to be substantially avoided. Depending on the thickness(es) of the workpiece(s), the type of connection (type of joint) and the material of the workpiece, there are hardly any limits to the design or dimensioning of the connection points.

As a result of the substantially homogeneous connection region, a dynamic increase in the load-bearing capacity is also possible in addition to the static increase, such that the workpieces which have been thermally connected according to the invention are used in dynamically, cyclically loaded regions. In vehicle construction in particular, these are components (component groups) of the chassis.

According to one embodiment, a workpiece with a first and a second workpiece section is provided, wherein the second workpiece section comprises an edge and the edge defines a termination of an edge section, and the two edges are connected to one another at least in certain sections in their longitudinal extent in order to generate an at least partially closed profile. With the method according to the invention, it is possible to provide a workpiece made of a one-piece material (workpiece) in the form of a profile/component that is closed at least in certain sections in longitudinal extent, preferably a profile/component that is completely closed in longitudinal extent with substantially largely minimized metallurgical and geometric notch sensitivity in the connection seam. The correspondingly produced profiles with closed cross section are particularly preferably suitable for further processing into components by way of in particular active-media-supported manufacturing technologies, since failure within the connection seam can be excluded.

According to an alternative embodiment, a first workpiece with a first workpiece section and a second workpiece with a second workpiece section are provided, wherein the two workpiece sections are connected to one another at least in certain sections in longitudinal extent in order to generate a workpiece group. With the method according to the invention, it is possible to connect a workpiece group or component group comprising at least two workpieces made of the same or different material with the same or different thickness to one another at least in certain sections in longitudinal extent, preferably to connect them to one another completely in longitudinal extent, and to provide a workpiece group or component group with substantially largely minimized metallurgical and geometric notch sensitivity in the connection seam. The workpieces can for example be designed as two half-shells, for example with a U- or C-shaped cross section, each having a base region with two respective protruding frame regions, such that said half-shells have a respective edge region over their respective at the end of the frames (frame regions), via which edge regions the half-shells can be connected to one another, in particular in a butt and/or lap joint, to form a workpiece group/component group with a cross section which is at least partially, preferably completely, closed in a longitudinal direction. Other embodiments of the workpiece group/component group, which for example deviate from a closed cross section, are also conceivable.

According to one embodiment, the edges are positioned at a distance from one another in the butt joint. This has the advantage that a predefined gap can be set over which, in dependence on the joining technology and wall thickness, a weld pool can be generated between the edges to be welded of the workpieces, in order not to weld above the connection seam. The distance or the gap between the edges is at most the thickness t of the workpiece with the smaller thickness.

According to an alternative embodiment, the edges are positioned so as to be in contact with one another at least in certain sections in the butt joint. The at least section-wise contact of the edges defines a technical zero gap, at least in certain sections, which can ensure a high-quality connection seam in particular when laser welding without filler material.

According to one embodiment, the edges are positioned with an edge height offset relative to one another in the butt joint. This edge height offset can be set in a deliberate manner by using, for example, two workpieces with the same thickness or alternatively by using workpieces with different thicknesses, the edge height offset preferably being set on the side facing the side which is thermally loaded in order to generate the connection seam. This has the advantage that, in particular in combination with sensor-based seam tracking, the edge joint can be detected and a connection can preferably be made in the ideal zero gap by means of triangulation.

According to one embodiment, the edge sections are each positioned at an angle relative to one another.

According to an alternative embodiment, the second workpiece section defines an edge section of the second workpiece and the edge sections are positioned relative one another in the lap joint. The edge sections are oriented substantially parallel to one another. In this case, at least one edge, in particular both edges or the one associated edge section or both associated edge sections has/have a geometry defined according to the invention

According to a further alternative embodiment, the second workpiece section defines a section of the second workpiece as a connecting section, wherein the edge section of the first workpiece and the section of the second workpiece are positioned relative to one another in a T-joint. The edge sections are oriented substantially parallel to one another. In this case, the edge or the associated edge section of the first workpiece has a geometry defined according to the invention.

According to one embodiment, the thermal connection is sensor-controlled. The sensor-controlled connection provides correspondingly suitable means with which the connection quality can be increased owing to the precise orientation/control of the thermal source. Exact orientation increases the repeatability and the process reliability. On account of the high process reliability, the connection/joining speed can be increased, which increases economic efficiency.

According to one embodiment, the thermal connection is effected by means of arc fusion welding, beam welding, pressure welding, soldering or hybrid methods including combinations thereof.

According to one embodiment, the workpiece used is an uncoated steel material or alternatively a steel material which is provided with a coating to protect against corrosion, in particular provided with a metallic coating, preferably provided with a zinc-based coating, and which has a tensile strength Rₘ>600 MPa. With the method according to the invention, it is possible for in particular sensitive dual-phase, complex-phase or Q+P steel materials with tensile strengths Rₘ>700 MPa, in particular Rₘ>800 MPa, preferably Rₘ>900 MPa, preferably Rₘ>1000 MPa, to be particularly preferably thermally connected to form workpiece groups/component groups.

In particular, the thickness of the workpiece or workpieces is constant and has a thickness of up to 4 mm, preferably up to 3.5 mm, preferably up to 3 mm, particularly preferably up to 2.5 mm, and has a thickness of at least 0.3 mm, in particular at least 0.5 mm, preferably at least 0.7 mm, particularly preferably at least 1 mm.

The workpiece is a workpiece made of a metal material, workpieces made of steel materials preferably being used. It is also conceivable to connect the workpieces made of aluminum materials with materials of the same type or of different types, for example also steel material with aluminum material.

According to a further aspect of the invention, a workpiece group, produced according to the invention, is used as part of a chassis or as part of a body of a vehicle, in particular a vehicle with an electric drive and/or with an internal combustion engine. In the preferred use as part of a vehicle chassis, it is possible to provide a resistant and robust workpiece group/component group which is designed in such a way that it withstands the cyclical loads in use and failure in the connection seam or in the HAZ can be substantially excluded.

### BRIEF DESCRIPTION OF THE DRAWINGS

The invention is explained in more detail below with reference to drawings. Identical parts are always provided with identical reference designations. In detail:

FIG. 1) shows a schematic partial sectional view of a first exemplary embodiment of a workpiece group,

FIG. 2) shows a schematic partial sectional view of a second exemplary embodiment of a workpiece group,

FIG. 3) shows a schematic partial sectional view of a third exemplary embodiment of a workpiece group,

FIG. 4) shows a schematic partial sectional view of a fourth exemplary embodiment of a workpiece group,

FIG. 5) shows a schematic partial sectional view of a fifth exemplary embodiment of a workpiece group and

FIG. 6) shows a schematic partial sectional view of a sixth exemplary embodiment of a workpiece group.

### DESCRIPTION OF THE PREFERRED EMBODIMENTS (BEST MODE FOR CARRYING OUT THE INVENTION)

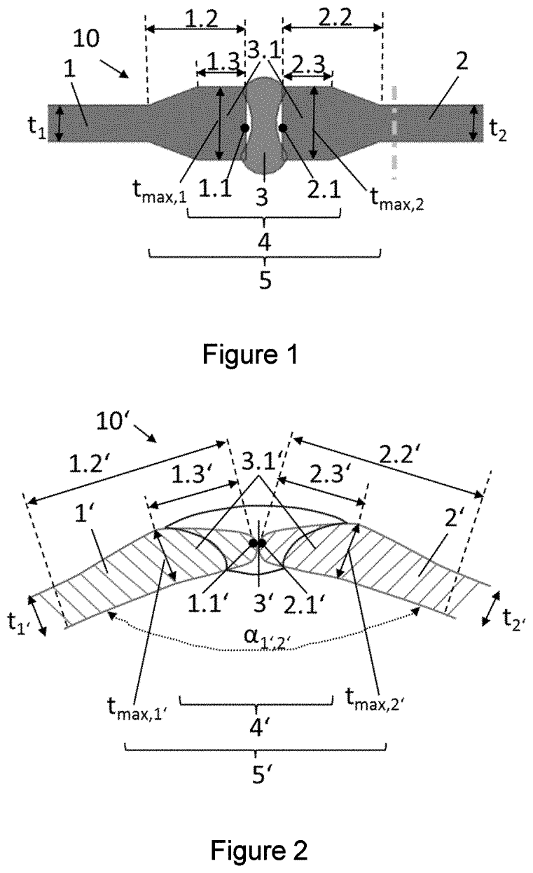

FIG. 1 illustrates a schematic partial sectional view of a first exemplary embodiment of a workpiece group (10). The workpiece group (10) has been produced according to the method according to the invention for thermally connecting at least two workpiece sections. A first workpiece (1) with a first workpiece section, which comprises an edge (1.1) and the edge (1.1) defines a termination of an edge section (1.2), and a second workpiece (2) with a second workpiece section, which comprises an edge (2.1) and the edge (2.1) defines a termination of an edge section (2.2), have been provided, wherein, in order to generate a workpiece group (10), the two workpiece sections have been connected to one another at least in certain sections in longitudinal extent, preferably completely in longitudinal extent, or are connected to one another via a connection seam (3). The thermal connection can be effected by means of arc fusion welding, beam welding (laser welding), soldering or hybrid methods including combinations thereof, wherein the edges (1.1, 2.1) are positioned at a distance from one another substantially in the butt joint. In this exemplary embodiment, the connection seam (3) was produced by means of laser hybrid welding. The workpieces (1, 2) can consist of the same or different material with the same or different thickness, the thicknesses (t_{1,2}) of the workpieces (1, 2) being the same in this exemplary embodiment. At least one of the workpieces (1, 2), in particular both workpieces (1, 2), consists/consist of an uncoated or coated steel material with a tensile strength Rₘ>600 MPa. At least one of the workpieces (1, 2) preferably consists of a dual-phase, complex-phase or Q+P steel material with a tensile strength Rₘ>700 MPa.

At least one of the edge sections (1.2, 2.2), in particular both edge sections (1.2, 2.2), has/have a defined geometry which is dimensioned in such a way that at least one section (1.3, 2.3) in the transverse extent of the edge section (1.2, 2.2) is provided with a maximum thickness (t_{max1,max2}), in particular with a substantially constant maximum thickness (t_{max1,max2}), proceeding from the edge (1.1, 2.1). The section (1.3, 2.3) or the width thereof is determined, inter alia, in dependence on the HAZ (3.1) and in particular on the region (5) of the metallurgical notch. The geometry of the edge section (1.2, 2.2) differs in particular from the geometry, in particular from the thickness (t_{1,2}), of the rest of the region of the workpiece (1, 2) and extends in a transverse direction substantially in the region (4) of the geometric notch and in particular in the region (5) of the metallurgical notch or covers said region.

FIG. 2 illustrates a schematic partial sectional view of a second exemplary embodiment of a workpiece group (10′). The workpiece group (10′) has been produced according to the method according to the invention for thermally connecting at least two workpiece sections. A first workpiece (1′) with a first workpiece section, which comprises an edge (1.1′) and the edge (1.1′) defines a termination of an edge section (1.2′), and a second workpiece (2′) with a second workpiece section, which comprises an edge (2.1′) and the edge (2.1′) defines a termination of an edge section (2.2′), are provided, wherein, in order to generate a workpiece group (10′), the two workpiece sections have been connected to one another at least in certain sections in longitudinal extent, preferably completely in longitudinal extent, or are connected to one another via a connection seam (3′). The thermal connection can be effected by means of arc fusion welding, beam welding, soldering or methods including combinations thereof, wherein the edges (1.1′, 2.1′) are positioned so as to be in contact with one another at least in certain sections substantially in the butt joint, and the edge sections (1.2′, 2.2′) are each positioned at an angle (α_{1,2}) relative to one another. In this exemplary embodiment, the connection seam (3′) was produced by means of MAG welding. The angle (α_{1′,2′}) is <180°, in particular <170°, with an angle of for example 150° not being undershot. The workpieces (1′, 2′) can consist of the same or different material with the same or different thickness, the thicknesses (t_{1′,2′}) of the workpieces (1′, 2′) being the same in this exemplary embodiment. At least one of the workpieces (1′, 2′), in particular both workpieces (1′, 2′), consists/consist of an uncoated or coated steel material with a tensile strength Rₘ>600 MPa. At least one of the workpieces (1′, 2′) preferably consists of a dual-phase, complex-phase or Q+P steel material with a tensile strength Rₘ>700 MPa.

At least one of the edge sections (1.2′, 2.2′), in particular both edge sections (1.2′, 2.2′), has/have a defined geometry which is dimensioned in such a way that a local region in the cross section of the edge section (1.2′, 2.2′) is provided with a maximum thickness (t_{max1′,max2′}) at a distance (1.3′, 2.3′) from the edge (1.1′, 2.1′). The geometry of the edge section (1.2′, 2.2′) differs in particular from the geometry, in particular from the thickness (t_{1′,2′}), of the rest of the region of the workpiece (1′, 2′) and extends in the transverse direction substantially in the region (5) of the metallurgical notch or covers said region. The thickness of the workpiece (1′, 2′) increases from the edge (1.1′, 2.1′) as far as the local region (1.3′, 2.3′) with the maximum thickness (t_{max1′,max2′}). In particular, the increase in thickness takes place within the region (4′) of the geometric notch. Within the edge section (1.2′, 2.2′), the thickness decreases from the local region (1.3′, 2.3′) with the maximum thickness (t_{max1′,max2′}), and leading away from the edge (1.1′, 2.1′), back to the (initial) thickness (t_{1′,2′}) of the workpiece (1′, 2′). The thickness thus varies along the cross section in the edge section (1.2′, 2.2′).

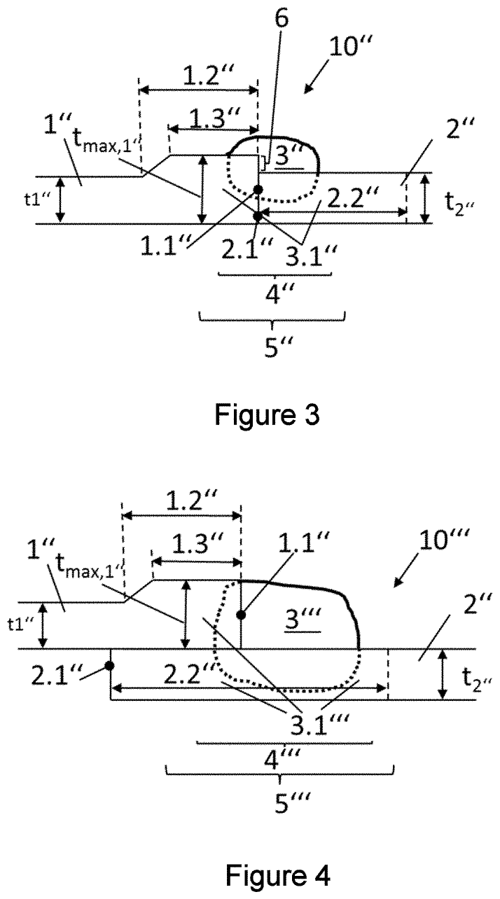

FIG. 3 illustrates a schematic partial sectional view of a third exemplary embodiment of a workpiece group (10″). The workpiece group (10″) has been produced according to the method according to the invention for thermally connecting at least two workpiece sections. A first workpiece (1″) with a first workpiece section, which comprises an edge (1.1″) and the edge (1.1″) defines a termination of an edge section (1.2″), and a second workpiece (2″) with a second workpiece section, which comprises an edge (2.1″) and the edge (2.1″) defines a termination of an edge section (2.2″), are provided, wherein, in order to generate a workpiece group (10″), the two workpiece sections have been connected to one another at least in certain sections in longitudinal extent, preferably completely in longitudinal extent, or are connected to one another via a connection seam (3″). According to the invention, only the edge section (1.2″) of the first workpiece (1″) has been dimensioned in such a way that a section (1.3″) in the transverse extent of the edge section (1.2″) is provided with a maximum thickness (t_{max1″}) proceeding from the edge (1.1″). The edge section (2.2″) of the second workpiece (2″) has a thickness (t_{2″}) that is substantially constant with the rest of the region of the workpiece (2″). Furthermore, the region (4″) of the geometric notch and the region (5″) of the metallurgical notch, and also the regions of the HAZ (3.1″), are illustrated. The edges (1.1″, 2.1″) have been positioned with an edge height offset (6) relative to one another, in particular with at least section-wise contact, substantially in the butt joint. This edge height offset (6) has been set on the side facing the side which is thermally loaded in order to generate the connection seam (3″). As a result, in combination with sensor-based seam tracking, the edge joint was detected and a connection was made in the ideal zero gap by means of triangulation. The thermal connection in this exemplary embodiment as well as in the other exemplary embodiments was carried out in a sensor-controlled manner, as a result of which the connection quality was increased owing to the precise orientation/control of the thermal source.

FIG. 4 illustrates a schematic partial sectional view of a fourth exemplary embodiment of a workpiece group (10′″). The workpiece group (10′″) has been produced according to the method according to the invention for thermally connecting at least two workpiece sections. A first workpiece (1″) with a first workpiece section, which comprises an edge (1.1″) and the edge (1.1″) defines a termination of an edge section (1.2″), and a second workpiece (2″) with an edge (2.1″) and a second workpiece section, which defines an edge section (2.2″), are provided, wherein, in order to generate a workpiece group (10″), the two workpiece sections have been connected to one another at least in certain sections in longitudinal extent, preferably completely in longitudinal extent, or are connected to one another via a connection seam (3′″). The edge sections (1.2″, 2.2″) have been positioned relative to one another in the lap joint. The edge sections (1.2″, 2.2″) are oriented substantially parallel to one another. In this case, only the edge (1.1″) or the associated edge section (1.2″) of the first workpiece (1″) has a geometry which has been changed compared with the rest of the region of the workpiece (1″), wherein a section (1.3″) in the transverse extent of the edge section (1.2″) is provided with a maximum thickness (t_{max1″}) proceeding from the edge (1.1″). This maximum thickness defines the maximum fillet weld thickness that can be realized. The edge section (2.2″) of the second workpiece (2″) has a thickness (t_{2″}) that is substantially constant with respect to the rest of the region of the workpiece (2″).

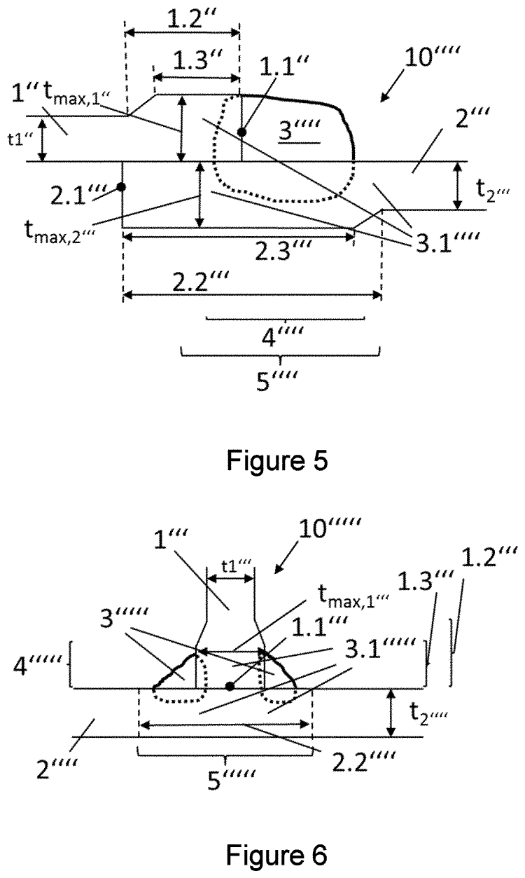

FIG. 5 illustrates a schematic partial sectional view of a fifth exemplary embodiment of a workpiece group (10′″). In comparison with the fourth exemplary embodiment, a second workpiece (2′″) has been taken into account which, like the first workpiece (1″), has a defined geometry of the edge (2.1′″) or of the edge section (2.2′−), wherein a section (2.3′″) in the transverse extent of the edge section (2.2′″) is provided with a maximum thickness (t_{max2′″}) proceeding from the edge (2.1′″). The section (1.3″, 2.3′″) or the width thereof is determined, inter alia, in dependence on the HAZ (3.1″″) and in particular on the region (5″″) of the metallurgical notch.

In addition to arc fusion welding for generating the connection seams (3′″, 3″″) in the fourth and fifth exemplary embodiments, pressure welding, in particular resistance spot welding, can alternatively also be used.

FIG. 6 illustrates a schematic partial sectional view of a sixth exemplary embodiment of a workpiece group (10′″″). The workpiece group (10′″″) has been produced according to the method according to the invention for thermally connecting at least two workpiece sections. A first workpiece (1′″) with a first workpiece section, which comprises an edge (1.1′″) and the edge (1.1′″) defines a termination of an edge section (1.2′″), and a second workpiece (2″″) with a second workpiece section, which defines a section (2.2″″) as a connecting section, are provided, wherein, in order to generate a workpiece group (10′″″), the two workpiece sections have been connected to one another at least in certain sections in longitudinal extent, preferably completely in longitudinal extent, or are connected to one another via two connection seams (3′″″). The edge section (1.2′″) of the first workpiece (1′″) and the section (2.2″″) of the second workpiece (2″″) have been positioned relative to one another in the T-joint, wherein the edge section (1.2′″) is oriented substantially perpendicular to the section (2.2″″). Only the edge (1.1′″) or the associated edge section (1.2′″) of the first workpiece (1′″) has a geometry which has been changed compared with the rest of the region of the workpiece (1′″), wherein a section (1.3′″) in the transverse extent of the edge section (1.2′″) is provided with a maximum thickness (t_{max1′″}) proceeding from the edge (1.1′″) The section (2.2″″) of the second workpiece (2″″) has a thickness (t_{2″″}) that is substantially constant with respect to the rest of the region of the workpiece (2″″). The section (1.3′″) or the width thereof is determined, inter alia, in dependence on the HAZ (3.1′″″) and in particular on the region (5′″″) of the metallurgical notch.

In principle, it is also possible for a profile/component which is made of a one-piece workpiece and which is closed at least in certain sections in longitudinal extent to be produced, the workpiece sections to be connected of the one workpiece being able to be designed, for example, like those in one of the six exemplary embodiments shown.

A standard workpiece group was produced from two workpieces made of an uncoated complex-phase steel material of HDT780C grade, each with a thickness t=2 mm, by means of a MAG weld. The two workpieces had a substantially constant thickness also in the edge sections as far as to the edges. The edges were positioned at a distance from one another which was smaller than the thickness of the workpieces, and the edge sections were positioned at an angle of approximately 160° relative to one another and connected to one another completely in longitudinal orientation. Investigations on the workpiece group showed that a region of a geometric notch had formed to the left and right of the edges with approximately +/−2.5 mm, and a region of a metallurgical notch, which substantially reflected and covered the HAZ, had formed to the left and right of the edges with approximately +/−5 mm. The hardness in the cross section of the workpieces was substantially approximately 300 HV 0.5, Vickers hardness determined in accordance with DIN EN ISO 6507-2. In the outer region of the HAZ, said region facing away from the connection seam, the hardness was approximately 250 HV 0.5, which corresponded to a relative drop in hardness of 20%. Analogously to the second exemplary embodiment, two workpieces (1′, 2′) with a defined edge section (1.2′, 2.2′) were connected to one another to form a workpiece group (10′) in the same way as the previously described workpieces. To compensate for the region (5′) of the metallurgical notch, the region in which the minimum hardness was determined in the HAZ of the workpiece group described above was locally reinforced. In order to compensate for the difference in hardness, a maximum thickness (t_{max1′,max2′}) of 2.4 mm was provided in the edge section (1.2′, 2.2′) at a distance (1.3′, 2.3′) of approximately 4 mm from the edge (1.1′, 2.1′), the relative increase corresponding to 20%. The edge section (1.2′, 2.2′) had a transverse extent of, or the width thereof was, approximately 7.5 mm. The standard workpiece group and the workpiece group (10′) were tested in a force-controlled cyclic vibration test and illustrated in a Wöhler diagram. On the one hand, it could be shown that the failure location for the standard workpiece group was in the region of the HAZ, and for the workpiece group (10′) failure occurred in the (base) material of the one workpiece and not in the connection region. Furthermore, this fracture behavior results in a higher dynamic fatigue strength of the workpiece group (10′).

The invention is not limited to the embodiments shown, but rather the individual features can be combined with one another as desired. Workpiece groups/component groups of different design can also be presented. By way of example, it is possible for only the edges of a one-piece workpiece to be connected to one another in order to generate a component/profile with closed cross section. The workpiece group (10, 10′, 10″, 10′″, 10″″) is used as part of a chassis or as part of a body of a vehicle. Use in other regions is also conveivable.

1. A method for thermally connecting at least two workpiece sections, wherein at least a first and a second workpiece section are provided, wherein at least the first workpiece section comprises an edge that defines a termination of an edge section, the first and second workpiece sections are positioned relative to one another in such a way that they are connected to one another at least in certain sections in their longitudinal extent, wherein the edge section has a defined geometry, wherein the defined geometry of the edge section is dimensioned in such a way that a local region in the cross section of the edge section is provided with a maximum thickness at a distance from the edge or at least one section in the transverse extent of the edge section is provided with a maximum thickness proceeding from the edge.

2. The method as claimed in claim 1, wherein a workpiece with a first and a second workpiece section is provided, wherein the second workpiece section comprises an edge and the edge defines a termination of an edge section, and the two edges are connected to one another at least in certain sections in their longitudinal extent in order to generate an at least partially closed profile.

3. The method as claimed in claim 1, wherein a first workpiece with a first workpiece section and a second workpiece with a second workpiece section are provided, and the two workpiece sections are connected to one another at least in certain sections in their longitudinal extent in order to generate a workpiece group.

4. The method as claimed in claim 1, wherein the edges are positioned at a distance from one another in a butt joint.

5. The method as claimed in claim 4, wherein the edges are positioned so as to be in contact with one another at least in certain sections in the butt joint.

6. The method as claimed in claim 5, wherein the edges are positioned with an edge height offset (6) relative to one another in the butt joint.

7. The method as claimed in claim 6, wherein the edge sections (1.2′, 2.2′) are each positioned at an angle (α_{1′, 2′}) relative to one other.

8. The method as claimed in claim 1, wherein the second workpiece section defines an edge section of the second workpiece, wherein the edge sections are positioned relative to one another in a lap joint.

9. The method as claimed in claim 1, wherein the second workpiece section defines a section of the second workpiece, wherein the edge section of the first workpiece and the section of the second workpiece are positioned relative to one another in a T-joint.

10. The method as claimed in claim 1, wherein the thermal connection is sensor-controlled.

11. The method as claimed in claim 1, wherein the thermal connection is effected by means of arc fusion welding, beam welding, pressure welding, soldering or hybrid methods including combinations thereof.

12. The method as claimed in claim 1, wherein the workpiece used is an uncoated or coated steel material with a tensile strength Rₘ>600 MPa.

13. A workpiece group produced as claimed in claim 3, wherein the workpiece group is used as part of a chassis or as part of a body of a vehicle.
